(19) United States
(12) Patent Application Publication
(10) Pub. No.: US 2026/0253386 A1
(43) Pub. Date: Aug. 27, 2026

(54) METHOD OF INDIVIDUAL IDENTIFICATION OF ANIMAL AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Naoki HAGIHARA, SHIOJIRI-SHI (JP); Ryoki WATANABE, Matsumoto-shi (JP); Hikaru KURASAWA, Matsumoto-shi (JP)

(21) Appl. No.: 19/549,108

(22) Filed: Feb. 25, 2026

(30) Foreign Application Priority Data
Feb. 26, 2025 (JP) 2025-028726

(51) Int. Cl. G06V 10/764; G06T 7/11; G06T 7/70

(52) U.S. Cl. CPC G06V 10/764; G06T 7/11; G06T 7/70; G06T 2207/10028

(57) ABSTRACT

A method of disclosure includes: (a) acquiring a p-th type image related to a backside of an animal; (b) obtaining a p-th type embedding vector using a p-th deep metric learning model; (c) calculating a p-th type distance between a p-th type registered embedding vector and the p-th type embedding vector related to each registered individual; and (d) determining which of the registered individuals the animal corresponds to using the p-th type distances. The step (d) includes (d1) obtaining a determination distance for each registered individual, (d2) determining that the registered individual is an individual of the animal when a minimum value of the determination distances is smaller than an threshold value set in advance, and (d3) determining that the animal is an unregistered individual when an non-registration condition including that the minimum value of the determination distances is larger than the threshold value is satisfied.

The present application is based on, and claims priority from JP Application Serial Number 2025-028726, filed February 26, 2025, the disclosure of which is hereby incorporated by reference herein in its entirety.

### BACKGROUND

### 1. Technical Field

The present disclosure relates to a method of individual identification of an animal and a non-transitory computer-readable storage medium storing a computer program.

### 2. Related Art

JP-A-2022-48464 discloses a technique for collating cow muzzle pattern images. In this related art, the muzzle pattern images are collated by extracting the muzzle pattern image from a face image of a cow, obtaining a feature vector of the muzzle pattern image using a neural network for classifying the muzzle pattern image, and calculating the similarity between that feature vector and a known feature vector.

JP-A-2022-48464 is an example of the related art.

However, in the related art, a face image having such high-resolution that a fine structure of the muzzle pattern can be discriminated is required, and there is a problem that it is difficult to acquire such a face image. For example, it is difficult to stop a movement of a cow that is continuously walking in order to take an image of that cow. Such a problem is not limited to individual identification of cows but is common to individual identification of other animals such as pigs. Therefore, there is a demand for a technique capable of performing individual identification using other features than the muzzle pattern.

### SUMMARY

According to a first aspect of the present disclosure, a method of performing individual identification of an identification target animal is provided. This method includes: (a) acquiring N1 p-th type target images using a p-th type image sensor with respect to a backside of the identification target animal, where p is an ordinal number from 1 to 2 and N1 is an integer no smaller than 1; (b) obtaining N1 p-th type embedding vectors from the N1 p-th type target images using a p-th deep metric learning model; (c) calculating N1×N2 p-th type distances between the N1 p-th type embedding vectors and N2 p-th type registered embedding vectors generated in advance for each of n registered individuals using registration data including the N2 p-th type registered embedding vectors, where n and N2 are integers no smaller than 2; and (d) determining whether the identification target animal corresponds to any of the n registered individuals using the N1×N2 p-th type distances related to each of the n registered individuals. The step (d) includes (d1) obtaining an integrated determination distance obtained by integrating N1×N2 first type distances and N1×N2 second type distances for each of the n registered individuals, (d2) determining that a registered individual corresponding to a minimum value of the integrated determination distances is an individual of the identification target animal when the minimum value of the integrated determination distances is smaller than an integrated threshold value set in advance, and (d3) determining that the identification target animal is an unregistered individual that does not correspond to any of the n registered individuals when a non-registration condition including that the minimum value of the integrated determination distances is larger than the integrated threshold value is satisfied.

According to a second aspect of the present disclosure, there is provided a non-transitory computer-readable storage medium storing a computer program configured to make a processor execute processing of individual identification of an identification target animal. This computer program makes the processor execute the processing including: (a) acquiring N1 p-th type target images using a p-th type image sensor with respect to a backside of the identification target animal, where p is an ordinal number from 1 to 2 and N1 is an integer no smaller than 1; (b) obtaining N1 p-th type embedding vectors from the N1 p-th type target images using a p-th deep metric learning model; (c) calculating N1×N2 p-th type distances between the N1 p-th type embedding vectors and N2 p-th type registered embedding vectors generated in advance for each of n registered individuals using registration data including the N2 p-th type registered embedding vectors, where n and N2 are integers no smaller than 2; and (d) determining whether the identification target animal corresponds to any of the n registered individuals using the N1×N2 p-th type distances related to each of the n registered individuals. The step (d) includes (d1) obtaining an integrated determination distance obtained by integrating N1×N2 first type distances and N1×N2 second type distances for each of the n registered individuals, (d2) determining that a registered individual corresponding to a minimum value of the integrated determination distances is an individual of the identification target animal when the minimum value of the integrated determination distances is smaller than an integrated threshold value set in advance, and (d3) determining that the identification target animal is an unregistered individual that does not correspond to any of the n registered individuals when a non-registration condition including that the minimum value of the integrated determination distances is larger than the integrated threshold value is satisfied.

### BRIEF DESCRIPTION OF THE DRAWINGS

FIG. 1 is a block diagram showing a configuration of an individual identification system.

FIG. 2 is a flowchart showing a procedure of learning of a deep metric learning model and generation of registration data.

FIG. 3 is a flowchart showing a detailed procedure of step S20.

FIG. 4 is a diagram illustrating the contents of generation processing of target images in step S20.

FIG. 5 is a diagram illustrating an example of the registration data.

FIG. 6 is a flowchart showing a procedure of individual identification processing in a first embodiment.

FIG. 7 is a diagram illustrating an example of embedding vectors calculated in the individual identification processing.

FIG. 8 is a diagram illustrating an example of distances between the embedding vectors and registered embedding vectors.

FIG. 9 is a flowchart showing a detailed procedure in step S140 in the first embodiment.

FIG. 10 is a diagram illustrating an example of various determination distances.

FIG. 11 is a flowchart showing a procedure of registration update processing.

FIG. 12 is a flowchart showing a detailed procedure in step S140 in a second embodiment.

FIG. 13 is a flowchart showing a detailed procedure in step S140 in a third embodiment.

### DESCRIPTION OF EMBODIMENTS

### A. First Embodiment

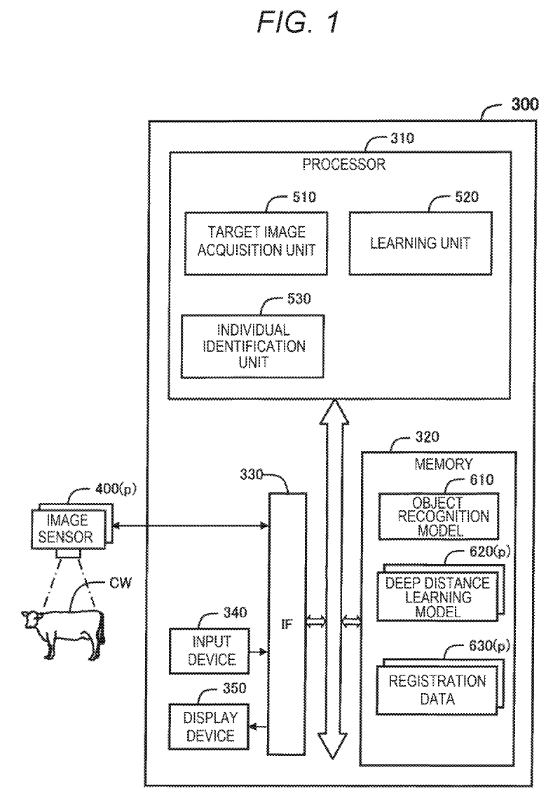

FIG. 1 is a diagram illustrating a configuration of an individual identification system according to a first embodiment. This individual identification system includes an information processing apparatus 300 and a plurality of image sensors 400(p). In the present embodiment, a processing target of individual identification is a cow CW. However, other animals such as pigs, dogs, and cats may be used as the processing target instead of cows.

The image sensor 400(p) is a camera that captures an image of the cow CW that is a target of individual identification processing. Each of the image sensors 400(p) is preferably installed so as to capture an image of a backside of the cow CW from above the cow CW. As the image sensor 400(p), a video camera that captures a moving image may be used, or a still image camera that captures a still image may be used. Further, as the image sensor 400(p), one or more of various sensors exemplified below can be used.

### (1) Depth Sensor

By using a depth image captured by a depth sensor, the individual identification can be performed based on unevenness of a backside of a cow.

### (2) RGB Sensor (Color Image Sensor)

By using a color image captured by an RGB sensor, the individual identification can be performed based on a monochrome pattern which is a mottled pattern on a backside of a cow. When there is dirt on the backside of a cow, the color image changes, and therefore, there is a possibility that erroneous recognition occurs when the individual identification is performed using only the RGB sensor. Meanwhile, the depth image captured by the depth sensor is not affected by dirt on a backside of a cow, and therefore has an advantage that the possibility of the erroneous recognition due to the dirt is low.

### (3) Spectral Sensor

By using a spectral image captured by a spectroscopic sensor, the individual identification can be performed based on monochrome patterns which are mottled patterns of respective wavelengths of a backside of a cow.

### (4) Thermosensor

By using a thermo-image captured by a thermosensor, the individual identification can be performed based on an intensity distribution of an infrared ray on a backside of a cow. The intensity distribution of the infrared ray on a backside of a cow is an image reflecting that the degree of scattering of the infrared ray changes depending on the length of the hair and that the distance changes due to the unevenness and the degree of diffusion of the infrared ray changes.

As the plurality of image sensors 400(p), a combination of different image sensors or a combination of the image sensors of same type can be used. When a combination of the image sensors of the same type is used, it is preferable to set the plurality of image sensors different in at least one attribute such as an installation angle or a field angle from each other. In the plurality of image sensors 400(p), it is preferable that relative positions of respective sensor coordinate systems are known and a coordinate transformation matrix related to any two sensor coordinate systems is known.

The number P of the image sensors 400(p) is an integer no smaller than 2. In the first embodiment, P=2 is set, and a moving image of the backside of the cow CW is captured using two image sensors 400, that is, the depth sensor and the RGB sensor. It is preferable that the depth sensor and the RGB sensor have substantially the same imaging region and are configured to be able to capture images at the same imaging timing. For example, one RGBD sensor including the depth sensor and the RGB sensor can be used as the image sensor 400(p).

The information processing apparatus 300 executes the individual identification of the cow CW using an image that is related to the backside of the cow CW and is captured by the image sensor 400(p). The information processing apparatus 300 includes a processor 310, a memory 320, an interface circuit 330, and an input device 340 and a display device 350 coupled to the interface circuit 330. The image sensor 400(p) is also coupled to the interface circuit 330. The processor 310 has not only a function of executing processing described in detail below, but also a function of displaying data obtained by that processing and data generated in the process of that processing on the display device 350. The information processing apparatus 300 can be realized by a computer such as a personal computer.

The processor 310 has functions of a target image acquisition unit 510, a learning unit 520, and an individual identification unit 530. The target image acquisition unit 510 acquires a plurality of target images from backside images captured by the image sensor 400(p). The learning unit 520 executes distance learning of P deep metric learning models 620(p). The individual identification unit 530 executes individual identification of the cow CW using the deep metric learning models 620(p) having been learned. The functions of these units are realized by the processor 310 executing a computer program stored in the memory 320. However, some of these functions may be implemented by a hardware circuit. The processor in the present disclosure is a term including such a hardware circuit. Further, one or more processors that execute the various types of processing may be processors provided to one or more remote computers coupled via a network.

The similarity may be used as the distance learned by the deep metric learning model 620(p). The high similarity corresponds to a small distance. That is, "small distance" is equivalent to "high similarity". In the following description, "distance" is used as a term including "similarity".

The memory 320 stores an object recognition model 610, P deep metric learning models 620(p), and P pieces of registration data 630(p). The object recognition model 610 is a machine learning model that takes an image of the cow CW as an input and a plurality of key points that are geometric feature points of the cow CW as an output. In the present embodiment, it is assumed that the object recognition model 610 has been learned. The object recognition model 610 can also be referred to as a "feature recognition model".

The deep metric learning model 620(p) is a machine learning model that takes the image of the cow CW as an input and an embedding vector as an output. The character p is an ordinal number from 1 to P representing the order of the deep metric learning model 620(p). The embedding vector is also referred to as a "feature vector". The deep metric learning model 620(p) can be configured using, for example, FaceNet.

In the following description, a reference symbol attached with (p) at the foot thereof means that the reference symbol corresponds to the ordinal number p of the deep metric learning model 620. Further, a prefix of "p-th type" also means that the prefix corresponds to the ordinal number p of the deep metric learning model 620.

The registration data 630(p) is a database in which an individual ID and a plurality of p-th type embedding vectors obtained using the p-th deep metric learning model 620(p) are registered for each of the plurality of registered individuals. The individual ID is, for example, an individual identification number displayed on an earmark of the cow CW. The p-th type embedding vector registered in the p-th registration data 630(p) is referred to as a "p-th type registered embedding vector". An image of each registered individual may be registered in the registration data 630(p) in addition to the p-th type registered embedding vector.

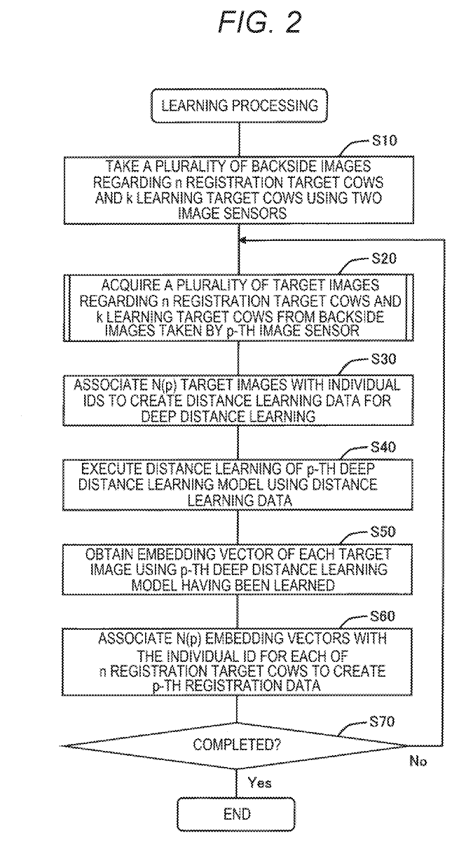

FIG. 2 is a flowchart illustrating a procedure of learning of the deep metric learning model 620(p) and generation of the registration data 630(p). In the following description, it is assumed that n is an integer no smaller than 2 and n registration target cows are registered in the registration data 630(p). In the present embodiment, the n registration target cows are the same in breed.

In step S10, the target image acquisition unit 510 captures a plurality of backside images related to the backside for each of the n registration target cows and k learning target cows using the two image sensors 400(p). Here, n and k are each an integer no smaller than 2. This image capturing can be performed when, for example, each cow sequentially passes below the image sensors 400(p). When a moving image is captured, a plurality of frame images is selected as the backside images from the moving image. This selection can be performed by, for example, automatically selecting the frame image including the backside portion of the registration target cow using an annotation tool. Alternatively, an operator may manually perform the selection.

In step S20, the target image acquisition unit 510 acquires a plurality of target images related to the backside for each of the n registration target cows and the k learning target cows from the backside images captured by the p-th image sensor 400(p). The "learning target cow" means a cow to be used to generate learning data of the deep metric learning model 620(p). In the deep distance learning, it is desirable to perform learning of the neural network using learning data different from the registration data 630(p) from the viewpoint of robustness. Further, it is desirable to generate the learning data so as to include more data than the registration data 630(p). Therefore, k is preferably set to a number greater than n. However, the learning target cows may include the registration target cow as a part thereof. Further, by setting n=k, the same cow may be used as both the learning target cow and the registration target cow. The number of target images acquired from each cow may be set to a constant value N(p), or may be set to a number different by individual cow. Here, N(p) is an integer that is no smaller than 1 and is defined with respect to the ordinal number p, but is preferably no smaller than 2. In addition, N(p) may be a constant value that does not depend on the ordinal number p.

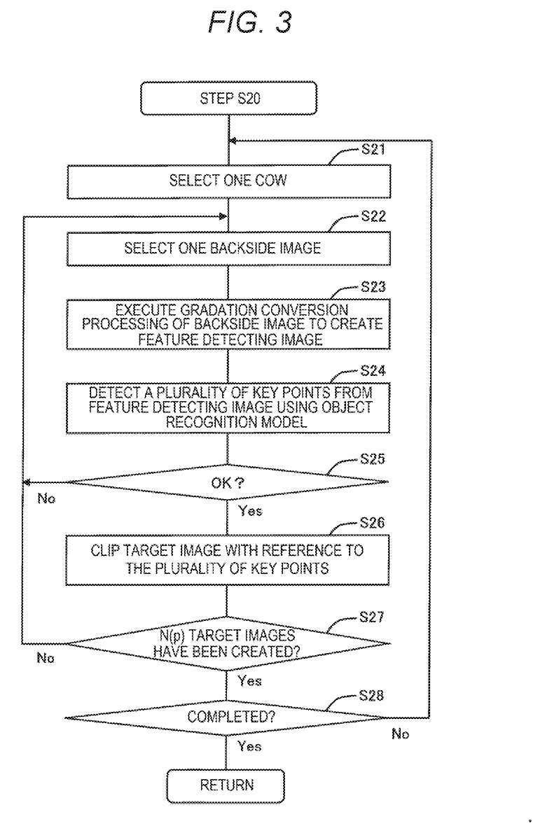

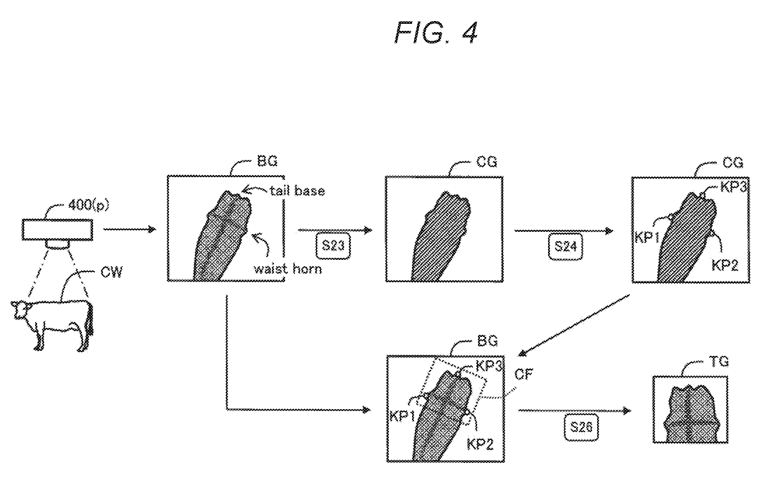

FIG. 3 is a flowchart showing a detailed procedure of step S20, and FIG. 4 is a diagram illustrating the processing contents thereof. In FIG. 4, a depth sensor is used as the image sensor 400(p). In FIG. 4, some of step numbers are added.

The backside image BG shown in FIG. 4 includes a rear portion of the cow CW including a waist angle and the base of the tail. Since the individual cow CW is characterized by a shape of the rear portion of the cow CW, the backside image BG preferably includes the rear portion of the cow CW including the waist angle and the base of the tail.

In step S21, the target image acquisition unit 510 selects one cow as a processing target from the n registration target cows and the k learning target cows. In step S22, the target image acquisition unit 510 selects one backside image BG as a processing target from the plurality of backside images BG. In step S23, the target image acquisition unit 510 generates a feature detecting image CG by executing gradation conversion processing of the backside image BG. The gradation conversion processing is processing of extracting a gradation range in which a contour of the cow is easily detected out of all gradations of the backside image BG and converting the backside image BG into an image having a predetermined number of gradations. For example, when the backside image BG, which is a depth image, is an image having 2400 gradations, the feature detecting image CG may be generated by extracting 512 intermediate gradations from the backside image BG and compressing the gradations to 256 gradations. However, step S23 may be omitted.

In step S24, the target image acquisition unit 510 detects a plurality of key points from the feature detecting image CG using the object recognition model 610. In the example of FIG. 4, two key points KP1, KP2 are detected at the position of the waist angle of the cow CW, and one key point KP3 is detected at the position of the base of the tail. These key points KP1 to KP3 are feature points present on an outline of the cow CW. The object recognition model 610 is a machine learning model that takes the feature detecting image CG as an input and the plurality of key points KP1 to KP3 as an output. However, the object recognition model 610 may be configured to recognize a key point representing another position. The object recognition model 610 can be configured using, for example, DeepLabCut or ResNet, which is a deep learning model. The object recognition model 610 may be configured using another machine learning model.

In step S25, the target image acquisition unit 510 determines whether a predetermined number of key points KP1 to KP3 are detected. When the predetermined number of key points KP1 to KP3 are not detected, the process returns to step S22, a new backside image BG is selected as a processing target, and the processing in step S23 and subsequent steps is executed once again. When the predetermined number of key points KP1 to KP3 are detected, the process proceeds to step S26.

In step S26, the target image acquisition unit 510 clips the target image TG from the backside image BG with reference to the plurality of key points KP1 to KP3. The target image TG is an image including a characterizing portion of the backside of the cow. In the example in FIG. 4, in the backside image BG, a state in which the clipping frame CF with reference to the key points KP1 to KP3 is set, and the target image TG clipped in accordance with the clipping frame CF are drawn. On this occasion, it is preferable to execute a rotation or a size change of the target image TG so that a direction or a size of the waist angle of the cow CW in the target image TG becomes a desired value. Further, pixel values of the target image TG may be normalized. This normalization is processing of, for example, normalizing the pixel value as a minimum depth value as 1.0, and the pixel value as a maximum depth value as 0, and further, converting the pixel values in a range of 0 to 1.0 into the gradations of 0 to 255. Note that steps S23 to S26 may be omitted to thereby use the backside image BG directly as the target image TG.

In step S27, the target image acquisition unit 510 determines whether N(p) target images TG have been generated for one cow. When the N(p) target images TG have not been generated, the process returns to step S22, a new backside image BG is selected as the processing target, and the processing in step S22 and subsequent steps is executed once again. When the N(p) target images TG have been generated, the process proceeds to step S28.

In step S28, the target image acquisition unit 510 determines whether the processing has been completed for all the n registration target cows and the k learning target cows. When the processing has not been completed for all the cows, the process returns to step S21, a new cow is selected as the processing target, and the processing in step S22 and subsequent steps is executed once again. When the processing is completed for all the cows, the processing in step S20 related to the p-th image sensor 400(p) ends.

Note that in the processing in FIG. 3 related to the image captured by the RGB sensor, similarly to the processing related to the image captured by the depth sensor, it is possible to detect the plurality of key points KP1 to KP3 from the backside image BG captured by the RGB sensor and set the clipping frame CF with reference to these key points. Alternatively, it is possible to convert the coordinates of the plurality of key points KP1 to KP3 detected from the backside image BG by the depth sensor into coordinates of the sensor coordinate system of the RGB sensor using a coordinate conversion matrix between the depth sensor and the RGB sensor, and set the clipping frame CF based on the key points KP1 to KP3 after the coordinate conversion. The latter method is particularly useful when the depth sensor and the RGB sensor are configured as a single RGBD sensor.

In step S30 in FIG. 2, the learning unit 520 generates distance learning data for the deep distance learning by associating N(p) target images TG acquired for each learning target cow with the individual ID. In step S40, the learning unit 520 executes the distance learning of the p-th deep metric learning model 620(p) using the distance learning data. This distance learning is processing of adjusting internal parameters of the deep metric learning model 620(p) such that the distance is short in the same individual and the distance is long in different individuals with respect to the p-th type embedding vectors output from the deep metric learning model 620(p). As the distance of the p-th type embedding vectors, for example, a Euclidean distance between the vectors may be used, or an angle between the vectors may be used.

In step S50, the learning unit 520 sequentially inputs N(p) target images TG related to each registration target cow to the p-th deep metric learning model 620(p) that has been learned, and obtains the p-th type embedding vector for each of the target images TG. As a result, N(p) p-th type embedding vectors are obtained for each registration target cow. In step S60, the learning unit 520 generates the p-th registration data 630(p) by associating N(p) p-th type embedding vectors with the individual ID for each of the n registration target cows.

In step S70, the learning unit 520 determines whether the processing has been completed for all the cases where the ordinal number p is 1 to P. When the processing is completed, the processing in FIG. 2 ends. When the processing is not completed, the process returns to step S20, and the processing in steps S20 to S70 is executed once again using the next value of the ordinal number p.

By performing the learning processing in FIG. 2 described above, P deep metric learning models 620(p) having been learned and P registration data 630(p) related to the n registration target cows are obtained. In the following description, the registration target cow is referred to as a "registered individual". Further, the p-th type embedding vector registered in the registration data 630(p) is referred to as a "p-th type registered embedding vector".

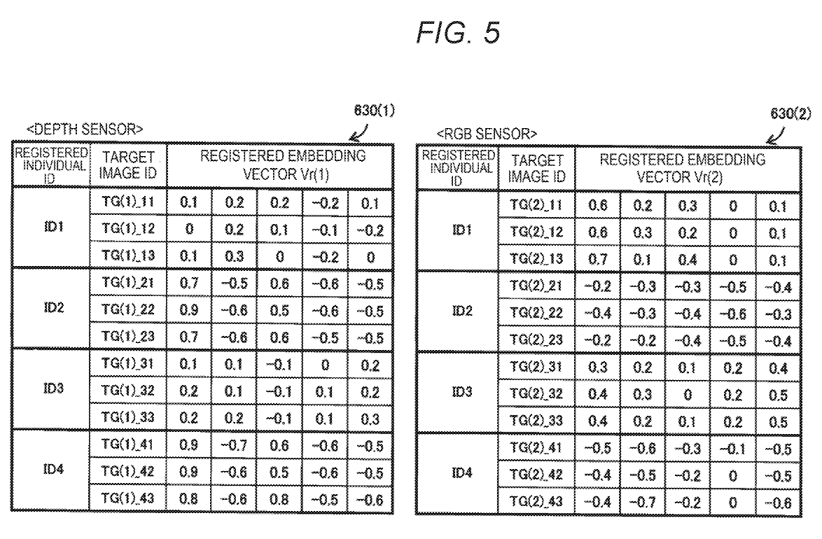

FIG. 5 is a diagram illustrating an example of the registration data 630(p). In this example, two image sensors, that is, the depth sensor and the RGB sensor are used as the P image sensors 400(p). Further, the number n of registration target cows is 4, and the number N(p) of target images TG is N(1)=N(2)=3. The registration data 630(p) includes first registration data 630(1) generated using the depth sensor and second registration data 630(2) generated using the RGB sensor. In the first registration data 630(1), registered embedding vectors Vr(1) related to three target images TG are registered for each of the four registered individuals. In this example, the registered embedding vectors Vr(1) are each a five-dimensional vector having five elements. The individual IDs of the four registered individuals are ID1 to ID4. Further, image IDs different from each other are assigned to the three target images TG obtained for each individual. However, the image IDs are not required to be registered. Also in the second registration data 630(2), registered embedding vectors Vr(2) related to three target images TG are registered for each of the four individuals that are the same as in the first registration data 630(1). Normally, a larger number of registered embedding vectors Vr(p) are registered for each registered individual, but in FIG. 5, the number of registered embedding vectors Vr(p) is reduced for the sake of convenience of illustration.

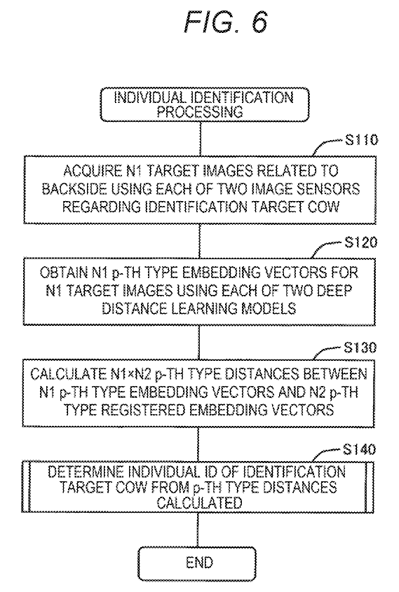

FIG. 6 is a flowchart illustrating a procedure of the individual identification processing. It is preferable that the individual identification processing is periodically performed on, for example, all cows reared in the same farm as identification target cows.

In step S110, the individual identification unit 530 acquires N1 target images TG related to the backside using each of the two image sensors 500(p) regarding one identification target cow. Here, N1 is an integer equal to or greater than 1. The value of N1 may be set to a value equal to the number of p-th type registered embedding vectors related to each of the registered individuals registered in the registration data 630(p), or may be set to a value different therefrom. In addition, N1 may be set to the number of target images TG that are acquired at that time regarding the identification target cow instead of a value set in advance. In the following description, the number of p-th type registered embedding vectors related to each registered individual is referred to as "N2" to be distinguished from the number N1 of target images TG of the identification target cow. The integer N2 is the same as the integer N(p) used in FIGS. 2 and 3, and is an integer no smaller than 2. In the example in FIG. 5, the number N2 of p-th type registered embedding vectors is 3. Note that each of the integers N1 and N2 is preferably a constant value that does not depend on the ordinal number p. The specific processing contents of step S110 are the same as the generation processing of the target image TG for the registration target cow described in FIGS. 3 and 4.

In step S120, the individual identification unit 530 obtains N1 p-th type embedding vectors regarding N1 target images TG using each of the two deep metric learning models 620(p) having been learned.

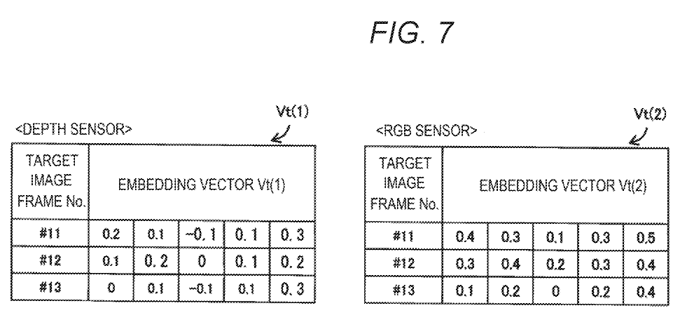

FIG. 7 is a diagram illustrating an example of an embedding vector calculated in the individual identification processing. In this example, the number N1 of target images TG is 3. That is, the first type embedding vector Vt(1) and the second type embedding vector Vt(2) are calculated related to each of three target images obtained for the identification target cow. The p-th type embedding vector Vt(p) is a vector of the same dimension as the p-th type registered embedding vector Vr(p) shown in FIG. 5.

In step S130, the individual identification unit 530 calculates a p-th type distance that is a distance between the N1 p-th type embedding vectors and the N2 p-th type registered embedding vectors related to each of the registered individuals. As a result, N1×N2 p-th type distances are calculated for each registered individual. In addition, since there are n registered individuals, n×N1×N2 p-th type distances are calculated using the p-th deep metric learning model 620(p) regarding one identification target cow. That is, n×N1×N2 p-th type distances are calculated from the images captured by each of the image sensors 400(p).

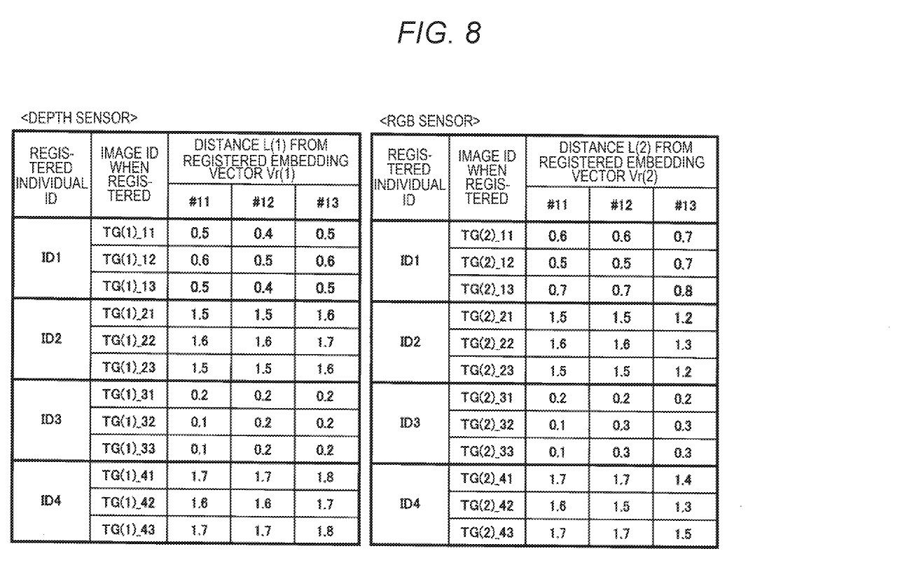

FIG. 8 is a diagram illustrating an example of the distances between the embedding vectors and the registered embedding vectors. Regarding the registered embedding vector Vr(p) shown in FIG. 5, n=4 and N2=3 are obtained, and regarding the embedding vector Vt(p) shown in FIG. 7, N1=3 is obtained. Therefore, 36 p-th type distances L(p) are calculated from the images captured by each of the image sensors 400(p) related to one identification target cow.

In step S140, the individual identification unit 530 determines the individual ID of the identification target cow from the p-th type distances calculated in step S130.

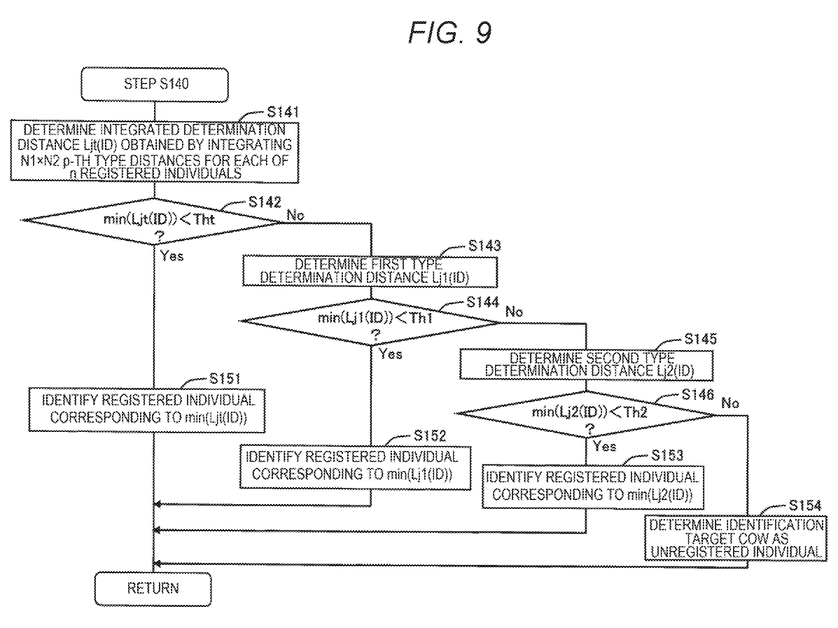

FIG. 9 is a flowchart showing a detailed procedure in step S140 in the first embodiment. In step S141, the individual identification unit 530 determines an integrated determination distance Ljt(ID) obtained by integrating N1×N2 p-th type distances for each of the n registered individuals. The integrated determination distance Ljt(ID) can be determined by, for example, any of the following methods.

### Method DM1 of Determining Integrated Determination Distance Ljt(ID)

For each of the registered individuals, a value proportional to an addition result obtained by adding a first type distance average value obtained by averaging M first type distances L(1) selected from the smallest value out of the N1×N2 first type distances L(1) and a second type distance average value obtained by averaging M second type distances L(2) selected from the smallest value out of the N1×N2 second type distances L(2) is determined as the integrated determination distance Ljt(ID). The value M is an integer no smaller than 2 and no larger than N1×N2, and is preferably an integer smaller than N1×N2. In addition, it is preferable that the integers N1, N2 are set so that N1×N2 is no smaller than 3. The "value proportional to the addition result" may be the addition result itself or may be a value obtained by multiplying the value by a positive coefficient.

### Method DM2 of Determining Integrated Determination Distance Ljt(ID)

For each of the registered individuals, M addition results are selected from the smallest value out of the N1×N2 addition results obtained by adding N1×N2 first type distances L(1) and the N1×N2 second type distances L(2) corresponding thereto, and a value proportional to an average value of the M addition results thus selected is determined as the integrated determination distance Ljt(ID). The term "corresponding" means a result obtained using the images captured at substantially the same capturing timing using the two image sensors 400(p). Specifically, the first type distance L(1) and the second type distance L(2) obtained respectively using the images of the same frame number captured by the depth sensor and the RGB sensor correspond to the distances "corresponding" to each other.

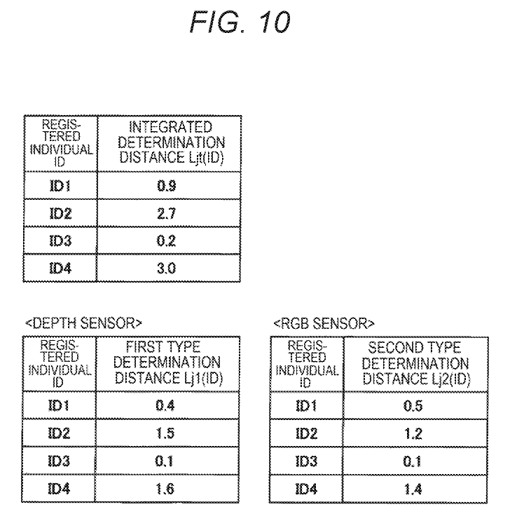

FIG. 10 is a diagram illustrating an example of various determination distances. An upper part of FIG. 10 illustrates an integrated determination distance Ljt(ID) calculated using M=3 and applying the determination method DM1 described above to the p-th type distances illustrated in FIG. 8.

In step S142 in FIG. 9, the individual identification unit 530 determines whether the minimum value of the integrated determination distances Ljt(ID) is smaller than the integrated threshold value Tht set in advance. When the minimum value of the integrated determination distances Ljt(ID) is smaller than the integrated threshold value Tht, the process proceeds to step S151, and the registered individual corresponding to the minimum value of the integrated determination distances Ljt(ID) is identified as the individual of the identification target cow. In the example in FIG. 10, since the minimum value of the integrated determination distances Ljt(ID) corresponds to the registered individual having the individual ID of ID3, this registered individual is identified as the individual of the identification target cow.

On the other hand, when the minimum value of the integrated determination distances Ljt(ID) is larger than the integrated threshold value Tht, the process proceeds to step S143. The minimum value of the integrated determination distances Ljt(ID) becomes larger than the integrated threshold value Tht when the identification target cow is an unregistered individual, or when there is dirt on the backside of the identification target cow. In this case, the identification determination is executed using a determination value different from the integrated determination distance Ljt(ID).

Note that when the minimum value of the integrated determination distances Ljt(ID) is equal to the integrated threshold value Tht, the process proceeds to a branch destination selected in advance out of the two branch destinations from step S142. The same applies to other determination steps using threshold values.

In step S143, the individual identification unit 530 determines first type determination distance Lj1(ID) representing N1×N2 first type distances L(1) for each of the n registered individuals. The first type determination distances Lj1(ID) are determined by, for example, any of the following methods.

### Method EM1 of Determining First Type Determination Distance Lj1(ID)

For each of the registered individuals, M1 first type distances L(1) are selected from the smallest values out of the N1×N2 first type distances L(1), and a value proportional to an average value of the M1 first type distances L(1) is determined as the first type determination distance Lj1(ID). Here, M1 is an integer no smaller than 2 and no larger than N1×N2, and is preferably an integer smaller than N1×N2. In addition, it is preferable that the integers N1, N2 are set so that N1×N2 is no smaller than 3.

### Method EM2 of Determining First Type Determination Distance Lj1(ID)

For each of the registered individuals, a value proportional to the minimum value of the N1×N2 first type distances L(1) is determined as the first type determination distance Lj1(ID). The "value proportional to the minimum value" may be the minimum value itself or may be a value obtained by multiplying the minimum value by a positive coefficient.

In the first embodiment, the first type determination distance Lj1(ID) is determined using M1=3 and applying the determination method EM1 described above to the p-th type distance shown in FIG. 8. A lower part of FIG. 10 shows the first type determination distances Lj1(ID) determined in this way.

In step S144, the individual identification unit 530 determines whether the minimum value of the first type determination distances Lj1(ID) is smaller than a first threshold value Th1 set in advance. When the minimum value of the first type determination distances Lj1(ID) is smaller than the first threshold value Th1, the process proceeds to step S152, and the registered individual corresponding to the minimum value of the first type determination distances Lj1(ID) is identified as the individual of the identification target cow.

On the other hand, when the minimum value of the first type determination distances Lj1(ID) is larger than the first threshold value Th1, the process proceeds to step S145. In step S145, the individual identification unit 530 determines second type determination distance Lj2(ID) representing N1×N2 second type distances L(2) for each of the n registered individuals. The second type determination distances Lj2(ID) are determined by substantially the same method as the determination methods EM1, EM2 of the first type determination distances Lj1(ID) described above. The lower part of FIG. 10 shows the second type determination distances Lj2(ID) calculated according to substantially the same method as the determination method EM1 described above.

In step S146, the individual identification unit 530 determines whether the minimum value of the second type determination distances Lj2(ID) is smaller than a second threshold value Th2 set in advance. When the minimum value of the second type determination distances Lj2(ID) is smaller than the second threshold value Th2, the process proceeds to step S153, and the registered individual corresponding to the minimum value of the second type determination distances Lj2(ID) is identified as the individual of the identification target cow.

On the other hand, when the minimum value of the second type determination distances Lj2(ID) is larger than the second threshold value Th2, the process proceeds to step S154. In step S154, the individual identification unit 530 determines that the identification target cow is an unregistered individual. The unregistered individual means an individual that does not correspond to any of the plurality of registered individuals registered in the registration data 630(p).

According to the processing in FIGS. 6 to 10 described above, the individual of the identification target cow can be determined from the N1×N2 p-th type distances related to each of the registered individuals. In particular, in the first embodiment, the individual can be identified using various determination distances including the integrated determination distance Ljt(ID). Further, when the N1×N2 p-th type distances satisfy the non-registration condition set in advance, it can be determined that the identification target cow is an unregistered individual.

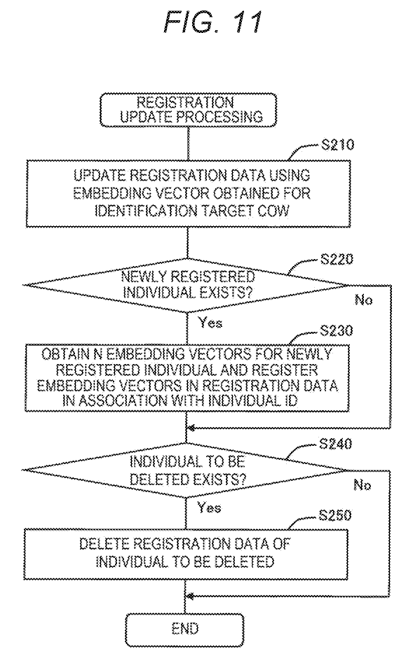

FIG. 11 is a flowchart illustrating a procedure of registration update processing. This registration update processing is preferably executed periodically, and is preferably executed, for example, once a day.

In step S210, the individual identification unit 530 updates the registration data 630(p) using the embedding vectors Vt obtained for the identification target cow in the processing in FIG. 9. For example, when N1=N2 is true, that is, when the number N1 of embedding vectors Vt obtained for the identification target cow is equal to the number N2 of registered embedding vectors Vr related to each of the registered individuals in the registration data 630(p), the registration data 630 may be updated so that the N(p) registered embedding vectors Vr are replaced with new N(p) embedding vectors Vt. Alternatively, the registration data 630 may be updated so as to add N1 embedding vectors Vt obtained for the identification target cow without discarding the old registered embedding vector Vr.

Further, when q is defined as an integer no smaller than 2, when the number N2 of registered embedding vectors Vr is equal to q×N1, the registration data 630 may be updated so as to discard the oldest N1 registered embedding vectors Vr, and add N1 embedding vectors Vt newly obtained for the identification target cow. In this way, the registration data 630(p) can be updated so as to always include the latest q×N1 registered embedding vectors Vr. Further, instead of updating the registration data 630(p) by adding the same number of registered embedding vectors Vr each time, the registration data 630(p) may be updated by adding a different number of registered embedding vectors Vr each time. That is, the number of registrations may be counted, and the registration data 630(p) may be updated so as to always include the registered embedding vectors Vr corresponding to q times of registration.

In step S220, the individual identification unit 530 determines whether there is a newly registered individual. The newly registered individual is an individual that is not registered in the registration data 630(p). For example, in the processing in FIG. 9, even when it is determined that the identification target cow is an unregistered individual, the identification target cow becomes a newly registered individual. Further, the user may designate a newly registered individual. When there is no newly registered individual, the process proceeds to step S240 described later. On the other hand, when there is a newly registered individual, the process proceeds to step S230, and the individual identification unit 530 obtains N(p) embedding vectors regarding the newly registered individual and registers the embedding vectors in the registration data 630(p) in association with the individual ID. Here, N(p) may be a value equal to the number N1 of embedding vectors Vt for the identification target cow used in step S210, or may be a value equal to the number N2 of registered embedding vectors Vr for each of the registered individuals in the registration data 630(p). The processing in step S230 is substantially the same as the processing in steps S10, S20, S50, and S60 in FIG. 2 described above.

In step S240, the individual identification unit 530 determines whether there is an individual to be deleted from the registration data 630(p). Whether there is an individual to be deleted is designated by the user. When there is no individual to be deleted, the processing in FIG. 10 ends. On the other hand, when there is an individual to be deleted, the process proceeds to step S250, and the individual identification unit 530 deletes the data of that individual from the registration data 630(p). By executing the processing in FIG. 10, the registration data 630(p) can be maintained at the latest content.

According to the first embodiment described above, the two types of embedding vectors Vt can be obtained from the target image TG related to the backside of the identification target cow using the two deep metric learning models 620(p), and an individual can be identified using various determination distances determined from the two types of distances of the two types of embedding vectors Vt and the two types of registered embedding vectors Vr. Further, since the identification target cow is identified using the two types of target images TG captured using the two types of image sensors 400(p), the identification accuracy can be improved compared to when one type of imaging sensor is used. Further, in the first embodiment, when the respective minimum values of the three determination distances Ljt(ID), Lj1(ID), and Lj2(ID) are larger than the respective threshold values Tht, Th1, and Th2, it can be determined that the identification target cow is an unregistered individual.

### B. Second Embodiment

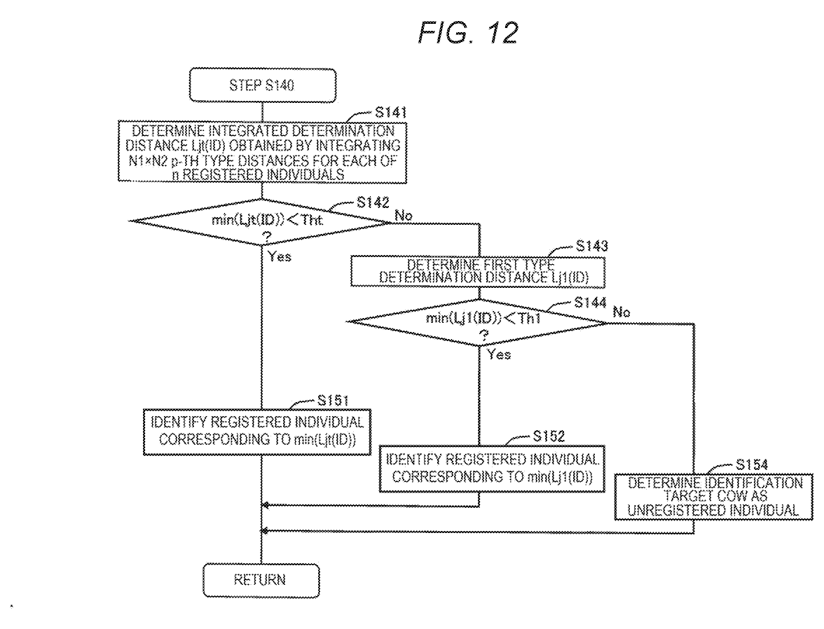

FIG. 12 is a flowchart showing a detailed procedure in step S140 in a second embodiment. The second embodiment is the same as the first embodiment in a configuration of the apparatus and the processing contents in FIGS. 2, 3, and 6. The processing procedure in FIG. 12 is what is obtained by omitting steps S145, S146, and S153 in FIG. 9, and is the same in other steps as that in the first embodiment.

In step S144 of the second embodiment, when the minimum value of the first type determination distances Lj1(ID) is larger than the first threshold value Th1, the process proceeds to step S154, and it is determined that the identification target cow is an unregistered individual.

The second embodiment has substantially the same advantages as those of the first embodiment. Further, according to the processing in FIG. 12 described above, when the minimum values of the integrated determination distances Ljt(ID) and the first type determination distances Lj1(ID) are larger than the respective threshold values Tht, Th1, it can be determined that the identification target cow is an unregistered individual.

### C. Third Embodiment

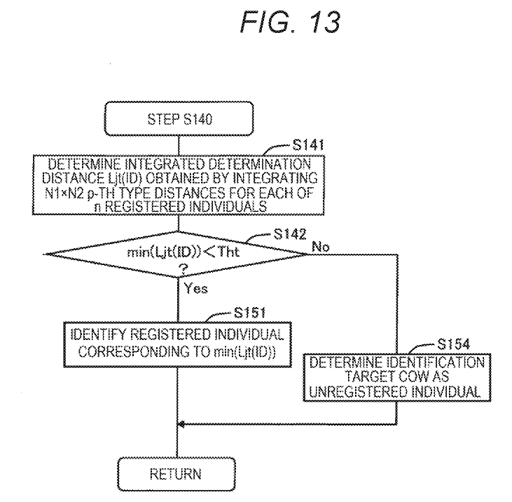

FIG. 13 is a flowchart showing a detailed procedure in step S140 in a third embodiment. The third embodiment is the same as the first embodiment and the second embodiment in a configuration of the apparatus and the processing contents in FIGS. 2, 3, and 6. The processing procedure in FIG. 13 is what is obtained by omitting steps S143, S144, and S152 in FIG. 12, and is the same in other steps as that in the second embodiment.

In step S142 of the third embodiment, when the minimum value of the integrated determination distances Ljt(ID) is larger than the integrated threshold value Tht, the process proceeds to step S154, and it is determined that the identification target cow is an unregistered individual.

The third embodiment also has substantially the same advantages as those of the first embodiment and the second embodiment. Further, according to the processing in FIG. 13 described above, when the minimum value of the integrated determination distances Ljt(ID) is larger than the threshold value Tht, it can be determined that the identification target cow is an unregistered individual.

Note that the individual identification processing in FIG. 9 in the first embodiment, the individual identification processing in FIG. 12 in the second embodiment, and the individual identification processing in FIG. 13 in the third embodiment are the same in that the identification target cow is determined to be an unregistered individual when an non-registration condition including that the minimum value of the integrated determination distances Ljt(ID) is larger than the integrated threshold value Tht is satisfied.

### Other Aspects

The present disclosure is not limited to the embodiments described above, and can be implemented in various forms without departing from the spirit of the present disclosure. For example, the present disclosure can be implemented by the following aspects. The technical features in the embodiments described above corresponding to the technical features in the aspects described below can be replaced or combined as appropriate in order to solve a part or all of the problems of the present disclosure, or to achieve a part or all of the advantages of the present disclosure. Further, any of the technical features can be eliminated as appropriate unless described as essential in the present specification.

(1) According to a first aspect of the present disclosure, a method of performing individual identification of an identification target animal is provided. This method includes: (a) acquiring N1 p-th type target images using a p-th type image sensor with respect to a backside of the identification target animal, where p is an ordinal number from 1 to 2 and N1 is an integer no smaller than 1; (b) obtaining N1 p-th type embedding vectors from the N1 p-th type target images using a p-th deep metric learning model; (c) calculating N1×N2 p-th type distances between the N1 p-th type embedding vectors and N2 p-th type registered embedding vectors generated in advance for each of n registered individuals using registration data including the N2 p-th type registered embedding vectors, where n and N2 are integers no smaller than 2; and (d) determining whether the identification target animal corresponds to any of the n registered individuals using the N1×N2 p-th type distances related to each of the n registered individuals. The step (d) includes (d1) obtaining an integrated determination distance obtained by integrating N1×N2 first type distances and N1×N2 second type distances for each of the n registered individuals, (d2) determining that a registered individual corresponding to a minimum value of the integrated determination distances is an individual of the identification target animal when the minimum value of the integrated determination distances is smaller than an integrated threshold value set in advance, and (d3) determining that the identification target animal is an unregistered individual that does not correspond to any of the n registered individuals when a non-registration condition including that the minimum value of the integrated determination distances is larger than the integrated threshold value is satisfied.

According to this method, two types of embedding vectors can be obtained from two types of target images related to the backside of the identification target animal using the two deep metric learning models, and the individual can be identified using the integrated determination distance determined from the distances between the two types of embedding vectors and the two types of registered embedding vectors. Further, when the p-th type distances satisfy the non-registration condition set in advance, it can be determined that the identification target animal is an unregistered individual.

(2) In the method described above, the integrated determination distance related to each of the n registered individuals may be a value proportional to a value obtained by adding a first type distance average value obtained by averaging M first type distances selected from a smallest value out of the N1×N2 first type distances and a second type distance average value obtained by averaging M second type distances selected from a smallest value out of the N1×N2 second type distances, where M is an integer no smaller than 2 and no larger than N1×N2.

According to this method, an appropriate integrated determination distance can be calculated.

(3) In the method described above, the step (d3) may include (d3-1) determining a first type determination distance representing the N1×N2 first type distances for each of the n registered individuals, and (d3-2) determining that a registered individual corresponding to a minimum value of the first type determination distances is an individual of the identification target animal when the minimum value of the n first type determination distances is smaller than a first type threshold value set in advance.

(4) In the method described above, the step (d3) may further include (d3-3) determining a second type determination distance representing the N1×N2 second type distances for each of the n registered individuals when the minimum value of the first type determination distances is larger than the first type threshold value, (d3-4) determining that a registered individual corresponding to the minimum value of the second type determination distances is an individual of the identification target animal when the minimum value of the n second type determination distances is smaller than a second type threshold value set in advance, and (d3-5) determining that the identification target animal is an unregistered individual that does not correspond to any of the plurality of registered individuals when the minimum value of the second type determination distances is larger than the second type threshold value.

According to this method, it is possible to determine whether the identification target animal is any of the registered individuals or an unregistered individual in accordance with the first type determination distances and the second type determination distances.

(5) In the method described above, the step (d3) may further include (d3-3) determining that the identification target animal is an unregistered individual that does not correspond to any of the plurality of registered individuals when the minimum value of the first type determination distances is larger than the first type threshold value.

According to this method, it is possible to determine whether the identification target animal is any of the registered individuals or an unregistered individual in accordance with the first type determination distances.

(6) In the method described above, the first type determination distance for each of the n registered individuals may be a value proportional to a first type distance average value obtained by averaging M first type distances selected from the smallest value out of the N1×N2 first type distances, where M is an integer no smaller than 2 and no larger than N1×N2.

According to this method, an appropriate first type determination distances can be calculated.

(7) In the method described above, the first type image sensor may be a depth sensor, and the second type image sensor may be an RGB sensor.

According to this method, the individual can be identified using the depth sensor and the RGB sensor.

(8) In the method described above, the step (a) may include (a1) acquiring a depth image and a color image related to the backside of the identification target animal using the depth sensor and the RGB sensor, (a2) detecting a plurality of key points from at least one of the depth image and the color image using an object recognition model, (a3) generating a first type target image by clipping a characterizing portion of the backside from the depth image with reference to positions of the plurality of key points, and (a4) generating a second type target image by clipping the characterizing portion of the backside from the color image with reference to the positions of the plurality of key points.

According to this method, the target image including the characterizing portion of the backside can be acquired from the depth image and the color image.

(9) According to a second aspect of the present disclosure, there is provided a non-transitory computer-readable storage medium storing a computer program configured to make a processor execute processing of individual identification of an identification target animal. This computer program makes the processor execute the processing including: (a) acquiring N1 p-th type target images using a p-th type image sensor with respect to a backside of the identification target animal, where p is an ordinal number from 1 to 2 and N1 is an integer no smaller than 1; (b) obtaining N1 p-th type embedding vectors from the N1 p-th type target images using a p-th deep metric learning model; (c) calculating N1×N2 p-th type distances between the N1 p-th type embedding vectors and N2 p-th type registered embedding vectors generated in advance for each of n registered individuals using registration data including the N2 p-th type registered embedding vectors, where n and N2 are integers no smaller than 2; and (d) determining whether the identification target animal corresponds to any of the n registered individuals using the N1×N2 p-th type distances related to each of the n registered individuals. The step (d) includes (d1) obtaining an integrated determination distance obtained by integrating N1×N2 first type distances and N1×N2 second type distances for each of the n registered individuals, (d2) determining that a registered individual corresponding to a minimum value of the integrated determination distances is an individual of the identification target animal when the minimum value of the integrated determination distances is smaller than an integrated threshold value set in advance, and (d3) determining that the identification target animal is an unregistered individual that does not correspond to any of the n registered individuals when a non-registration condition including that the minimum value of the integrated determination distances is larger than the integrated threshold value is satisfied.

The present disclosure can be implemented in various forms other than the above. For example, the present disclosure can be implemented in the form of an apparatus that realizes the individual identification processing or a non-transitory storage medium storing the computer program.

What is claimed is:

1. A method of individual identification of an identification target animal, the method comprising:
(a) acquiring N1 p-th type target images using a p-th type image sensor with respect to a backside of the identification target animal, where p is an ordinal number from 1 to 2 and N1 is an integer no smaller than 1;
(b) obtaining N1 p-th type embedding vectors from the N1 p-th type target images using a p-th deep metric learning model;
(c) calculating N1×N2 p-th type distances between the N1 p-th type embedding vectors and N2 p-th type registered embedding vectors generated in advance for each of n registered individuals using registration data including the N2 p-th type registered embedding vectors, where n and N2 are integers no smaller than 2; and
(d) determining whether the identification target animal corresponds to any of the n registered individuals using the N1×N2 p-th type distances related to each of the n registered individuals, wherein
the step (d) includes
(d1) obtaining an integrated determination distance obtained by integrating N1×N2 first type distances and N1×N2 second type distances for each of the n registered individuals,
(d2) determining that a registered individual corresponding to a minimum value of the integrated determination distances is an individual of the identification target animal when the minimum value of the integrated determination distances is smaller than an integrated threshold value set in advance, and
(d3) determining that the identification target animal is an unregistered individual that does not correspond to any of the n registered individuals when a non-registration condition including that the minimum value of the integrated determination distances is larger than the integrated threshold value is satisfied.

2. The method according to claim 1, wherein
the integrated determination distance related to each of the n registered individuals is a value proportional to a value obtained by adding a first type distance average value obtained by averaging M first type distances selected from a smallest value out of the N1×N2 first type distances and a second type distance average value obtained by averaging M second type distances selected from a smallest value out of the N1×N2 second type distances, where M is an integer no smaller than 2 and no larger than N1×N2.

3. The method according to claim 1, wherein
the step (d3) includes
(d3-1) determining a first type determination distance representing the N1×N2 first type distances for each of the n registered individuals, and
(d3-2) determining that a registered individual corresponding to a minimum value of the first type determination distances is an individual of the identification target animal when the minimum value of the n first type determination distances is smaller than a first type threshold value set in advance.

4. The method according to claim 3, wherein
the step (d3) further includes
(d3-3) determining a second type determination distance representing the N1×N2 second type distances for each of the n registered individuals when the minimum value of the first type determination distances is larger than the first type threshold value,
(d3-4) determining that a registered individual corresponding to the minimum value of the second type determination distances is an individual of the identification target animal when the minimum value of the n second type determination distances is smaller than a second type threshold value set in advance, and
(d3-5) determining that the identification target animal is an unregistered individual that does not correspond to any of the plurality of registered individuals when the minimum value of the second type determination distances is larger than the second type threshold value.

5. The method according to claim 3, wherein
the step (d3) further includes
(d3-3) determining that the identification target animal is an unregistered individual that does not correspond to any of the plurality of registered individuals when the minimum value of the first type determination distances is larger than the first type threshold value.

6. The method according to claim 3, wherein
the first type determination distance for each of the n registered individuals is a value proportional to a first type distance average value obtained by averaging M first type distances selected from a smallest value out of the N1×N2 first type distances, where M is an integer no smaller than 2 and no larger than N1×N2.

7. The method according to claim 1, wherein
the first type image sensor is a depth sensor, and the second type image sensor is an RGB sensor.

8. The method according to claim 7, wherein
the step (a) includes
(a1) acquiring a depth image and a color image related to the backside of the identification target animal using the depth sensor and the RGB sensor,
(a2) detecting a plurality of key points from at least one of the depth image and the color image using an object recognition model,
(a3) generating a first type target image by clipping a characterizing portion of the backside from the depth image with reference to positions of the plurality of key points, and
(a4) generating a second type target image by clipping the characterizing portion of the backside from the color image with reference to the positions of the plurality of key points.

9. A non-transitory computer-readable storage medium storing a computer program configured to make a processor execute processing of individual identification of an identification target animal, the processing comprising:
(a) acquiring N1 p-th type target images using a p-th type image sensor with respect to a backside of the identification target animal, where p is an ordinal number from 1 to 2 and N1 is an integer no smaller than 1;
(b) obtaining N1 p-th type embedding vectors from the N1 p-th type target images using a p-th deep metric learning model;
(c) calculating N1×N2 p-th type distances between the N1 p-th type embedding vectors and N2 p-th type registered embedding vectors generated in advance for each of n registered individuals using registration data including the N2 p-th type registered embedding vectors, where n and N2 are integers no smaller than 2; and
(d) determining whether the identification target animal corresponds to any of the n registered individuals using the N1×N2 p-th type distances related to each of the n registered individuals, wherein
the step (d) includes
(d1) obtaining an integrated determination distance obtained by integrating N1×N2 first type distances and N1×N2 second type distances for each of the n registered individuals,
(d2) determining that a registered individual corresponding to a minimum value of the integrated determination distances is an individual of the identification target animal when the minimum value of the integrated determination distances is smaller than an integrated threshold value set in advance, and
(d3) determining that the identification target animal is an unregistered individual that does not correspond to any of the n registered individuals when a non-registration condition including that the minimum value of the integrated determination distances is larger than the integrated threshold value is satisfied.
